(19) United States
(12) Patent Application Publication
(10) Pub. No.: US 2025/0303644 A1
(43) Pub. Date: Oct. 2, 2025

(54) ENERGY DIRECTOR FOR ULTRASONIC WELDING OF THERMOPLASTIC COMPOSITES

(71) Applicant: Wichita State University, Wichita, KS (US)

(72) Inventors: Waruna Seneviratne, Wichita, KS (US); Mark Walthers, Wichita, KS (US); John Tomblin, Wichita, KS (US)

(21) Appl. No.: 19/091,259

(22) Filed: Mar. 26, 2025

Related U.S. Application Data
(60) Provisional application No. 63/570,067, filed on Mar. 26, 2024.

(51) Int. Cl. B29C 65/00; B29C 65/08

(52) U.S. Cl. CPC B29C 66/3022; B29C 65/085; B29C 66/721

(57) ABSTRACT

In a method of using ultrasonic welding for fusion bonding of thermoplastic composites, an energy director is formed in place on a first thermoplastic substrate. The energy director can be protrusions arranged in a grid pattern over the entire weld region. The energy director can have protrusions of varying thicknesses to account for unevenness along the weld interface. Forming the energy director can be carried out by placing thermoplastic film on the first thermoplastic substrate, melting the thermoplastic film, and stamping the thermoplastic film with an energy director stamp. After the energy director is formed, the first thermoplastic substrate is ultrasonically welded to a second thermoplastic substrate with the energy director sandwiched between the first and second thermoplastic substrates.

### CROSS-REFERENCE TO RELATED APPLICATION

This application claims priority to U.S. Provisional Patent Application No. 63/570,067, filed Mar. 26, 2024, which is hereby incorporated by reference in its entirety.

### STATEMENT REGARDING FEDERALLY SPONSORED RESEARCH OR DEVELOPMENT

This invention was made with government support under Cooperative Agreement Number 12-C-AM-WISU, awarded by the FAA. The government of the United States has certain rights in the invention.

### BACKGROUND

Reinforced thermoplastic composites are an attractive material solution for many commercial and defense vehicle applications due to their ability to reduce manufacturing cycle time and cost. Additionally, thermoplastic composites have superior toughness and environmental resistance compared to thermoset composites and reduce the need for using mechanical fasteners at joints.

Current methods of joining composite parts together include mechanical fastening, adhesive bonding, and welding. However, mechanical fastening induces stress concentrations around holes, adds weight, and may cause galvanic corrosion. In the case of adhesive bonding, extensive surface preparation and longer curing times are common. Fusion bonding can achieve strength close to the bulk property of the parent material with long-term integrity while eliminating the problems associated with adhesion bonding and mechanical fastening. However, previous developments in thermoplastic fusion present challenges due to a common occurrence of delamination at the weld interface. Therefore, in order to weld thermoplastic composites while maintaining structural integrity, new systems and methods are needed.

### SUMMARY

In one aspect, a method of using ultrasonic welding for fusion bonding of thermoplastic composites comprises forming an energy director in place on a first thermoplastic substrate. The first thermoplastic substrate is ultrasonically welded to a second thermoplastic substrate with the energy director sandwiched between the first and second thermoplastic substrates. Said forming the energy director comprises placing thermoplastic film on the first thermoplastic substrate, melting the thermoplastic film, and stamping the thermoplastic film with an energy director stamp.

In another aspect, a method of using ultrasonic welding for fusion bonding of thermoplastic composites comprises forming an energy director in place on a first thermoplastic substrate. The first thermoplastic substrate is ultrasonically welded to a second thermoplastic substrate with the energy director sandwiched between the first and second thermoplastic substrates. Said forming the energy director comprises forming energy director protrusions arranged in a grid pattern.

In another aspect, a thermoplastic composite weld layup comprises a thermoplastic composite substrate having a weld joint region and a thermoplastic energy director formed in place along the weld joint region. The thermoplastic energy director comprises thermoplastic film stamped onto the weld joint region such that the film material forms discrete energy director protrusions arranged in a grid pattern along the weld joint region.

Other aspects and features will be apparent hereinafter.

### DESCRIPTION OF THE DRAWINGS

FIG. 1 is a fragmentary schematic illustration of a weld layup including an energy director formed in accordance with the present disclosure;

FIG. 2 is a schematic illustration of a roller stamp forming an energy director from film;

FIG. 3 is a schematic illustration of a block stamp forming an energy director from film;

FIG. 4 is a schematic illustration of a robot with a roller stamp end effector;

FIG. 5 is a perspective of an additive manufacturing robot;

FIG. 6 is a schematic illustration of an ultrasonic spot welding process;

FIG. 7 is a schematic illustration of a sequential ultrasonic welding process;

FIG. 8 is a schematic illustration of a continuous ultrasonic welding process;

FIG. 9 is a perspective of a continuous welding tool above an example weld layup;

FIG. 10 is a perspective of a pressurization sled for the welding tool;

FIG. 11 is a perspective of a roller assembly for the welding tool;

FIG. 12 is a perspective showing a welding tool supported on a gantry motion system;

FIG. 13 is a flow chart showing a method of ultrasonic welding in accordance with the present disclosure;

FIGS. 14A-14E are photographs showing samples of example weld layups subjected to testing;

FIGS. 15A-15E are micrographs showing samples of the example weld layups after welding; and

FIG. 16 is a chart showing metrics related to the apparent shear strength of the weld joints of the examples.

Corresponding reference characters indicate corresponding parts throughout the drawings.

### DETAILED DESCRIPTION

Fusion bonding shows promising advantages over other joining techniques such as mechanical fastening and adhesives, as fusion bonding can achieve strength close to the bulk property of the parent material with long-term integrity. Several types of fusion bonding could be used to weld thermoplastic composites, such as ultrasonic welding, resistance welding, and induction welding. Ultrasonic welding seems to be initially advantageous because it is faster and more cost-effective for mass production and automated processes. For these reasons, ultrasonic welding has extensive application and potential in fields such as electronics, medical technology, aerospace, and the automotive industries.

Disclosed herein are systems and methods for ultrasonic welding of thermoplastic composites. Broadly, ultrasonic welding functions according to the principle of frictional heat generation at a welding interface through the application of high-frequency mechanical vibration to melt the polymer. Pressure and vibration are simultaneously applied by a sonotrode (horn) connected to a piezoelectric generator, which are together responsible for converting high frequency alternating current into mechanical vibrations. The substrates are held under pressure before and after the vertical oscillations are induced to promote sufficient welding pressure and control cooling.

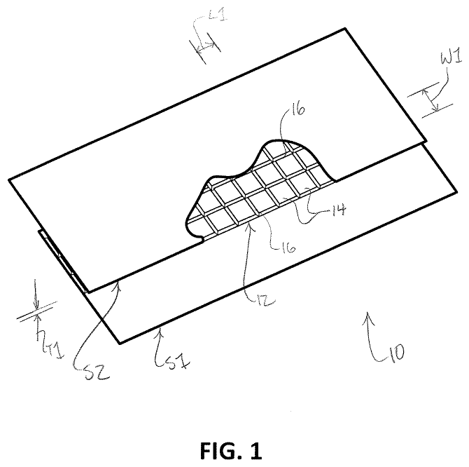

Referring now to FIG. 1, an exemplary ultrasonic welding layup in accordance with the present disclosure is shown schematically at reference number 10. The welding layup 10 broadly comprises a first thermoplastic substrate S1 and a second thermoplastic substrate S2 with opposing faying surfaces. Here, the term “substrate” is being used for the purpose of distinguishing the thermoplastic components that are present in the weld layup 10 prior to joining the components together from a thermoplastic part that is formed from two or more such components welded together. The thermoplastic substrates S1, S2 can have any suitable shape or function and can be formed from any suitable thermoplastic material. In one example, the first thermoplastic substrate S1 is a skin panel and the second thermoplastic substrate S2 is a reinforcement member (e.g., stringer, rib, etc.) to be joined to the skin panel. In suitable embodiments, the thermoplastic substrates are formed from the same type of thermoplastic material. In certain example embodiments, the type of material is one of a Toray TC1225 (T700GC/LMPAEK) or a Solvay APC (AS4D/PEKK) thermoplastic composite. However, it should be known that other materials may be used without departing from the scope of the present disclosure.

In the weld layup 10 depicted in FIG. 1, an energy director 12 is positioned (e.g., sandwiched) between the first and second thermoplastic substrates S1, S2. In general, the energy director 14 comprises thermoplastic material formed on at least one faying surface to have a shape that is thought to improve the application of mechanical energy and heat between the faying surfaces during ultrasonic welding. The application of the energy director 12 is believed to improve the melt flow of thermoplastic material between the two substrates S1, S2 by ensuring the melting process is localized to the faying surfaces. This controlled welding approach and ultimately improves the mechanical properties of the ultrasonic weld.

In the illustrated embodiment, the energy director 12 comprises a grid of protrusions 14 formed on the faying surface of the first thermoplastic substrate S1. As will be explained in further detail below, the illustrated energy director 14 is formed in place on the faying surface of the first thermoplastic substrate S1. For example, the first thermoplastic substrates S1 can initially comprise a smooth faying surface before the energy director 12 is formed on the surface. In certain embodiments, the faying surface of the second thermoplastic substrate S2 opposite the energy director 12 is smooth. In other embodiments, a second energy director (not shown) is formed in place on the faying surface of the second substrate S2.

In the illustrated embodiment, each of protrusions 14 has a generally rectangular shape in plan. In other embodiments, the energy director could comprise protrusions of other shapes without departing from the scope of the disclosure. Here the rectangular protrusions 14 each have a protrusion length L1, a protrusion width W1, and a protrusion thickness T1. In one embodiment, each protrusion 14 has the same length L1 and each protrusion has the same width W1 (e.g., the protrusions are all about the same size in plan). In certain embodiments, the length L1 of each protrusion 14 is about the same as the width W1 (e.g., the protrusions are generally square in plan). The protrusions 14 may have uniform thicknesses T1, or the thicknesses of the protrusions may vary for reasons that will be explained in further detail below. In one or more embodiments, the protrusion length L1 can be in an inclusive range of from 0.05 inches to 0.5 inches (e.g., 0.1 inches to 0.25 inches), the protrusion width W1 can be in an inclusive range of from 0.05 inches to 0.5 inches (e.g., 0.1 inches to 0.25 inches), and the protrusion thickness T1 can be in an inclusive range of from 50 μm to 600 μm (e.g., 100 μm to 500 μm).

Adjacent protrusions 14 are separated from one another by narrow channels 16. In the illustrated embodiment, the channels 16 include a set of first channels running lengthwise and a set of second channels running widthwise. The first channels 16 are generally parallel to one another and spaced apart along the width of the energy director 12. The second channels 16 are also generally parallel to one another and spaced apart along the length of the energy director. The first channels 16 intersect the second channels. The first channels 16 are generally perpendicular to the second channels in the illustrated embodiment. In one or more embodiments, the energy director 12 comprises at least four first channels 16 running lengthwise so as to define at least five lengthwise columns of protrusions. In an example embodiment, the energy director 12 comprises at least four second channels 16 running widthwise so as to define at least five widthwise columns of protrusions.

Suitably, the energy director 12 is formed from a thermoplastic material (e.g., resin) that is compatible with the composite materials used for the first and second substrates S1, S2. For example, in an embodiment, each of the substrates S1, S2 is a thermoplastic composite comprising reinforcing fibers contained in a thermoplastic resin matrix and the energy director 12 is formed from resin made of the same type of thermoplastic material that forms the resin matrix for each of the first and second substrates.

In an exemplary method of ultrasonic welding in accordance with the present disclosure, the energy director 12 is formed in place on the first thermoplastic substrate S1 before the second thermoplastic substrate S2 is ultrasonically welded to the first thermoplastic substrate. Various methods of forming the energy director in place on the first thermoplastic substrate S1 can be used without departing from the scope of the disclosure.

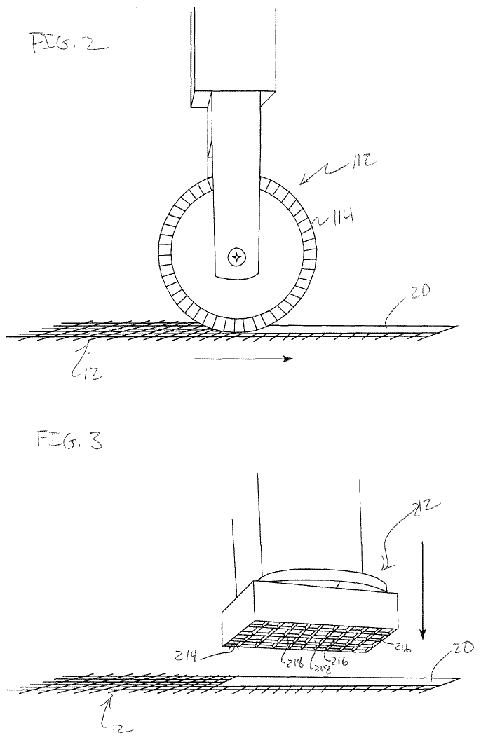

Referring to FIGS. 2-3, in one embodiment the energy director 12 is formed in place on the first thermoplastic substrate S1 by placing (smooth and/or flat) thermoplastic film 20 on the first thermoplastic substrate, melting the thermoplastic film in place on the first thermoplastic substrate, and stamping the thermoplastic film with an energy director stamp 112, 212. In certain embodiments, the energy director stamp 112, 212 comprises a heated stamp that heats the film 20 to melt the film simultaneously with stamping the film. In other embodiments, the method can comprise heating the film to its melt temperature before impressing the energy director stamp 112, 212 onto the film. Various energy director stamps 112, 212 can be used without departing from the scope of the disclosure. In a suitable embodiment, the energy director stamp 112, 212 can comprise a waffle-shaped stamping surface 114, 214 that forms the energy director film 20 into a grid of raised rectangular protrusions 14 when stamped.

An example waffle-shaped stamping surface 214 is shown well in FIG. 3. It can be seen that the waffle-shaped stamping surface 114, 214 comprises lengthwise and widthwise ribs 216 that correspond with the narrow channels 16 in an energy director 12. The ribs 216 bound depressions 218 that correspond in size and shape with the protrusions 14 of the energy director 12. The person skilled in the art will recognize that when a waffle-shaped stamping surface 114, 214, like the one depicted in FIG. 3, is impressed upon the melted resin of the film 20, the stamping surface will form an imprint in the resin that creates the protrusions 14 and channels 16 of the energy director 12.

In one embodiment depicted in FIG. 2, the energy director stamp 112 comprises a roller (e.g., a heated roller) having a stamping imprint formed on an outer surface of the roller 114. With the energy director stamp 112, the step of stamping the melted film comprises rolling the roller along the film strip 20. In another embodiment depicted in FIG. 3, the energy director stamp 212 comprises a block with a stamping imprint formed on a distal end surface 214. With the energy director 212, the step of stamping comprises pressing the stamp block distally onto the film 20. The stamping bock 212 can be sequentially impressed onto the film at spaced apart locations to form an energy director 12 with a surface area larger than the stamping surface 214.

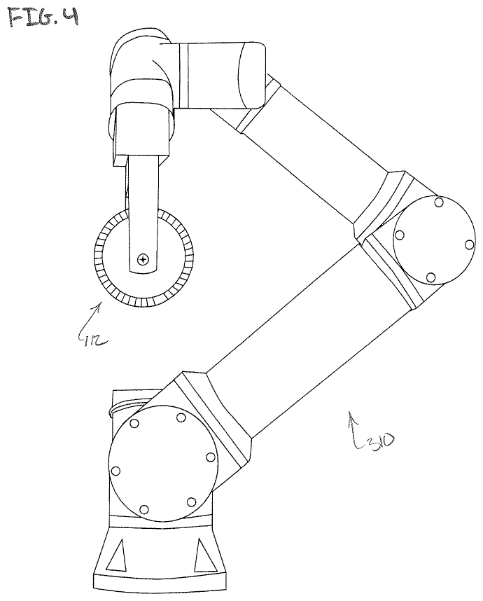

The step of stamping the film 20 can be performed manually or automatically. One suitable example of a stamping robot for automatically stamping the film 20 to form an energy director 10 is generally indicated at reference number 310 in FIG. 4. In the illustrated example, the robot 310 is a multi-axis robot arm and the roller stamp 112 is connected to the robot arm as an end effector. As will be apparent to the person skilled in the art, the robot 310 can be programmed to automatically roll the roller stamp 112 along a film 20 that has been applied to the faying surface of a first thermoplastic substrate S1. In certain embodiments, the robot 310 can be configured to energize a heating element (not shown) contained in the stamping end effector 112 to simultaneously melt and stamp the film 20.

As an alternative to forming the energy director 12 by applying a film and then stamping the film, in another embodiment, the energy director is formed by additively manufacturing the protrusions 14 in place on the faying surface of the first thermoplastic substrate S1. Referring to FIG. 5, an example of a robotic additive manufacturing system that can be used to form the energy director 12 in place on the thermoplastic substrate S1 is generally indicated at reference number 410. In general, the system 410 comprises a multi-axis industrial robot 412 and an additive manufacturing end effector 414 configured for thermoplastic additive manufacturing. In this embodiment, the energy director 12 is formed by depositing, via additive manufacturing, a grid of thermoplastic resin protrusions 14 on the faying surface to define narrow channels 16 between adjacent protrusions. In certain embodiments, the additive manufacturing end effector 414 is used to deposit an energy director primitive, e.g., primitive energy director protrusions, onto the faying surface. Subsequently, an automated machining tool is used to machine the energy director primitive to have a final energy director shape. In some embodiments, this two-stage process can be performed using a single SCRAM robot. The SCRAM robot is a 6-axis robot produced by Electroimpact, capable of additively manufacturing 3D continuous fiber-reinforced structures and performing fused filament fabrication.

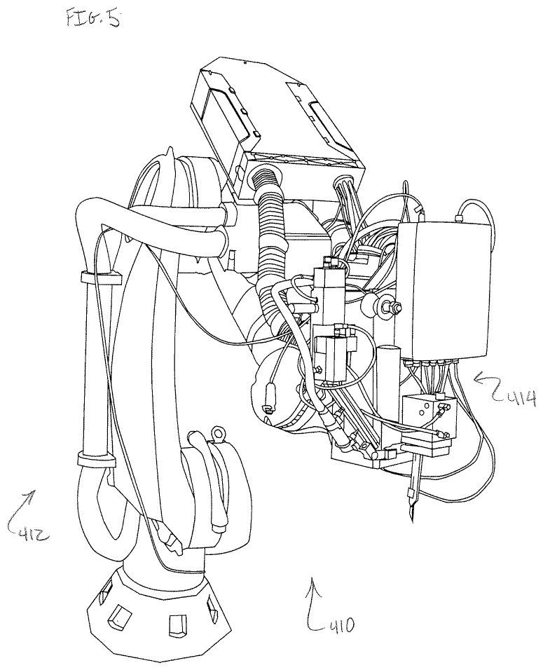

Referring to FIGS. 6-8, after the energy director 12 is formed on the faying surface of the first thermoplastic substrate S1, the second thermoplastic substrate S2 is placed on the first substrate and the two substrates are ultrasonically welded together to form a part. Various ultrasonic welding techniques can be employed without departing from the scope of the disclosure. Broadly, the process of ultrasonic welding comprises pressing a sonotrode 510 against the surface of at least one substrate S2 and vibrating the sonotrode at an ultrasonic frequency.

In at least one embodiment for use on an industrial scale, two or more robots may be used in combination to provide an improved process for welding complex industrial-sized structures, such as those with contours. One robot may move the ultrasonic welding end effector and the other robot may provide counter pressure opposite the welding side. The substrates being welded may be supported by a fixture temporarily holding the parts while the weld is being completed. This configuration allows for welding without the use expensive tooling.

The specific ultrasonic welding process parameters used when forming the weld (e.g., time, temperature, pressure, tooling, fixturing, weld speed/rate, resistance, frequency, amplitude, induction coil, cooling solutions, and horn design) may vary without departing from the scope of the disclosure. Heat generation during ultrasonic welding is dependent on welding pressure, vibrational frequency, amplitude, and time. Commonly, ultrasonic welding occurs at a high frequency, such as 20 kHz. According to manufacturers in the industry, in order to weld semi-crystalline polymers at a frequency of 20 kHz, an amplitude between 70 μm and 120 μm is recommended.

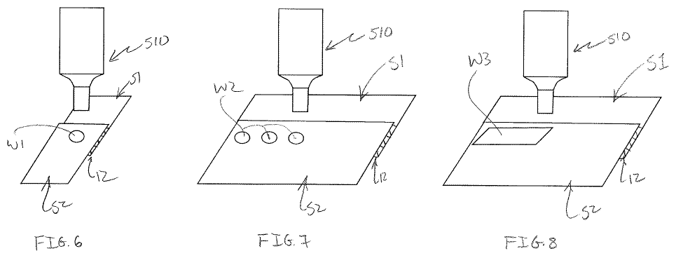

Those skilled in the art will understand that various types of ultrasonic welds can be formed depending on the application. FIG. 6 schematically illustrates a method in which a sonotrode 510 is applied at a single location to make an ultrasonic spot weld W1. FIG. 7 schematically illustrates a method in which the sonotrode 510 is applied at a plurality of spaced apart locations to make a sequential ultrasonic weld W2. FIG. 8 schematically illustrates yet another method in which the sonotrode is translated continuously along the weld region while applying ultrasonic energy to form a continuous ultrasonic weld W3.

Referring to FIG. 9, an exemplary embodiment of an ultrasonic welding tool for making a continuous ultrasonic weld is generally indicated at reference number 610. FIG. 9 shows the tool 610 approaching an example weld layup comprising a first thermoplastic substrate S1 (a skin panel segment) and a second thermoplastic substrate S2 (an omega stringer segment). An energy director (not shown) is formed on the upper surface of the thermoplastic skin panel segment S1 beneath the flange of the omega stringer S2. The ultrasonic welding tool 610 comprises a sonotrode 510 configured to receive and apply vibrations to make a weld between the substrates S1, S2. The ultrasonic welding tool 610 further comprises a pressure applicator system 612 configured to press the second substrate S2 toward the first substrate S1 to keep the weld layup compressed while the ultrasonic energy is being applied. The pressure applicator system 612 comprises a leading pressurization element 614 (broadly, a first pressurization element) and a trailing pressurization element 616 (broadly, a second pressurization element). The sonotrode 510 is located between the first and second pressurization elements 614, 616.

The leading pressurization element 614 is configured to apply pressure to the weld layup 10 ahead of the sonotrode 510 to create a pre-pressurization zone, and the trailing pressurization element 616 is configured to apply pressure to the weld layup behind the sonotrode to create a deconsolidation mitigation zone. The pre-pressurization zone (applied by the leading pressurization element 614) brings the part up to the desired weld pressure gradually, while the deconsolidation mitigation zone (applied by the trailing pressurization element 616) limits the risk of deconsolidation occurring. In addition, the trailing pressurization element 616 may function as a heat sink, which aids in crystallization development. Each pressurization element 614, 616 may be independently controlled (e.g., by a respective linear actuator 618, 620) in order to apply non-uniform pressures to the pre-pressurization zone and the deconsolidation zone. Further, each of the pressurization elements 614, 616 may be adjusted in the x, y, and z directions for precise placement of pressure. In one embodiment, the trailing pressurization element 616 is positioned as close to the sonotrode as possible without interfering with the weld. Placing the trailing pressurization element 616 close to the sonotrode further mitigates deconsolidation as the weld continues.

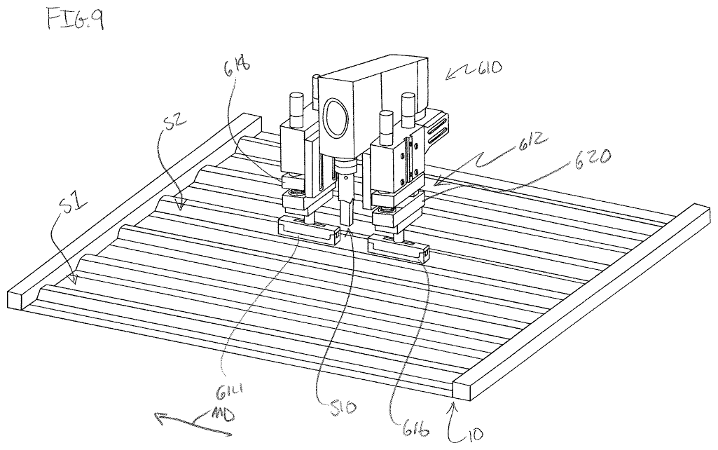

In an embodiment, one or both of the leading and trailing pressurization elements 614, 616 comprises a pressurization sled. Referring to FIG. 10, one example of a suitable pressurization sled is generally indicated at reference number 710. The pressurization sled 710 has a radius corner 712 at a leading end of the sliding surface 714. The radius corner 712 decreases the likelihood of the sled 710 snagging or grabbing fibers as pressurization element 614, 616 moves along the surface of the substrate S2. The pressurization sled 710 may be made of any material that acts as a heat sink.

Referring to FIG. 11, in another embodiment, one or both of the leading and trailing pressurization elements 614, 616 comprises a roller assembly 810. The roller assembly 810 comprises a carriage 812 supporting wheels 816 so that the wheels are configured to roll along substrate S2 without snagging on fibers. Suitably, the wheels 816 may comprise compaction rollers that are configured for compacting the weld layup 10 while the continuous weld is being formed. Optionally, the roller assembly 810 further comprises a suspension system 818 (e.g., springs loaded between the carriage 812 and the wheels 816) configured to adjust to a change in thickness or contour of the substrates S1, S2.

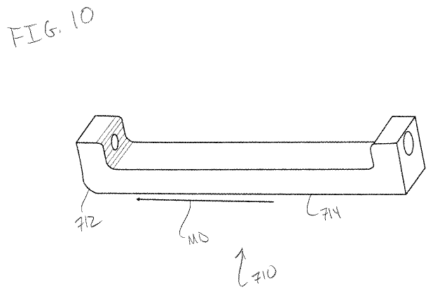

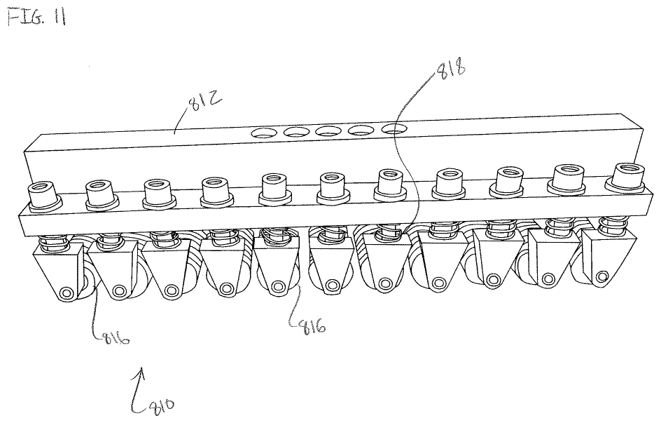

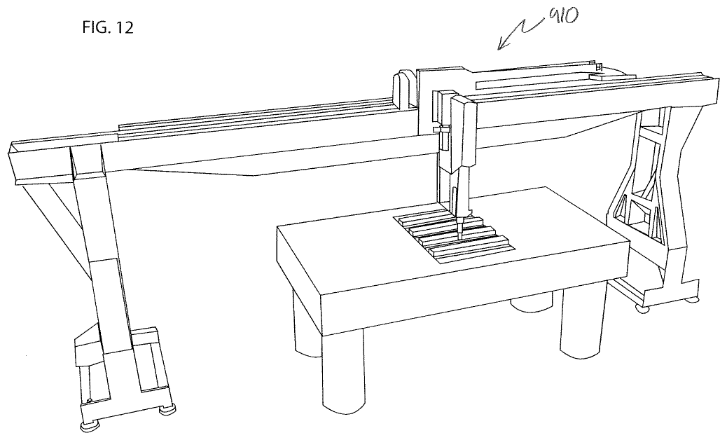

Referring to FIG. 9, in one or more embodiments, the ultrasonic welding tool 610 further comprises a movement system (not shown) configured to move the sonotrode 510 along the weld layup 10 in a movement direction MD. One example of a suitable movement system is the gantry system 910 shown in FIG. 12. Another example of a suitable movement system is a multi-axis industrial robot. Still other movement systems may be used without departing from the scope of the disclosure.

During use of the ultrasonic welding tool 610, the movement system moves the sonotrode 510 and pressure applicator system 612 along the weld layup 10 in the movement direction MD while the sonotrode applies ultrasound energy and the pressure applicator system applies pressure to the pre-pressurization zone and the deconsolidation zone. That is, the pressure applicator system 612 (i) compresses the first and second thermoplastic substrates S1, S2 together ahead of the sonotrode 510 in the movement direction MD using the first pressurization element 614 and (ii) compresses the first and second thermoplastic substrates together behind the sonotrode relative the movement direction using the second pressurization element 616 while the sonotrode applies vibrations and pressure to make a weld between the first and second thermoplastic substrates.

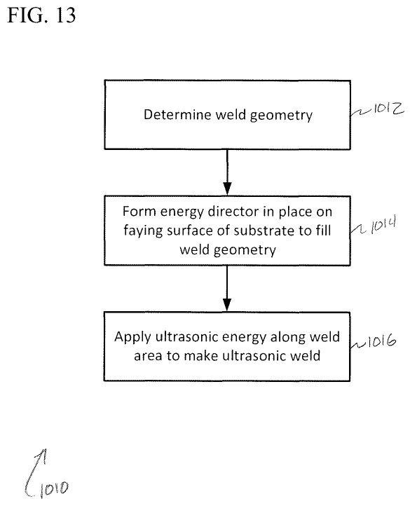

Referring now to FIG. 13, an exemplary method of making an ultrasonic weld between thermoplastic composite substrates S1, S2 is shown schematically at reference number 1010. The method 1010 begins with a first step 1012 of determining the weld geometry. In one example, step 1012 comprises determining the surface area (e.g., length and width) for the ultrasonic weld.

In a further example, step 1012 comprises dry fitting the first and second substrates S1, S2 together and inspecting the interface between the faying surfaces to locate any gaps along the intended contact plane. This can be done manually, through visual inspection, or using an automated non-destructive testing instrument such as a laser scanner, photogrammetry system, etc. Further, in addition to locating the gaps, in some embodiments, the non-destructive testing instrument can be used to measure or otherwise characterize the gap. Those skilled in the art will appreciate that, when two thermoplastic composite substrates are stacked together, the opposing faying surfaces frequently do not meet up perfectly in the intended contact plane. As explained below, once such gaps are located they can be accounted for by custom-forming the energy director 12 to fill the gaps.

After the weld geometry is determined in step 1012, the method 1010 comprises a step 1014 of forming the energy director 12 in place on the faying surface of at least one substrate S1, S2 so that the energy director fills the weld geometry. The notion of “filling the weld geometry” fulfills one or both of the following criteria: (1) the energy director 12 spans the entire surface area (e.g., length and width) of the weld geometry determined in step 1012; and/or (2) the energy director 12 has a varied thickness that accounts for the gaps between the dry-fit substrates S1, S2 located in step 1012.

In accordance with the present disclosure, criteria (1) is satisfied when an energy director 12 is formed in place on at least one faying surface so that the protrusions 14 are distributed over substantially the entire surface area of the determined weld geometry. For example, in one embodiment this is accomplished by (i) placing thermoplastic resin film on the faying surface along the weld area so that the applied film has a length and width both greater than or equal to the desired length and width of the weld geometry, (ii) heating the resin film in place on the faying surface to melt the resin, and (iii) stamping the melted resin film to form a grid pattern of protrusions 14 and narrow channels 16 that spans a length and width that are both greater than or equal to the desired length and width of the weld geometry. In another embodiment, criteria (1) is achieved by additively manufacturing thermoplastic resin onto the faying surface of a thermoplastic substrate S1 to form a grid pattern of protrusions 14 and narrow channels 16 that spans a length and width that are both greater than or equal to the specified length and width for the weld. It can be seen that an energy director 12 formed in place in accordance with this method will have protrusions 14 distributed across the entire surface area of the weld. In one or more embodiments, the protrusions 14 fill a substantial majority of the weld surface area in the sense that the aggregate surface area of the tops of the protrusions 14 (which excludes any surface area occupied by the channels) is greater than 60% (e.g., greater than 70%, greater than 75%, greater than 80%) of the entire surface area of the weld.

As explained above, an energy director 12 may also be considered to fill the entire weld geometry under criteria (2) when the thickness of the energy director is varied along the weld to improve the fit between uneven faying surfaces. For example, in one or more embodiments, criteria (2) is achieved by (i) placing a first layer thermoplastic resin film on the faying surface along the entire weld area; (ii) placing at least one second layer of thermoplastic resin film atop the first layer along selected locations of the weld area (e.g., corresponding to the locations of gaps between the faying surfaces of the substrates S1, S2 when the substrates were dry fit in step 1012); (iii) heating the resin film in place on the faying surface to melt the resin; and (iv) stamping the melted resin film to form a grid pattern of protrusions 14 and narrow channels 16 along the weld area. In another embodiment, criteria (2) is achieved by additively manufacturing thermoplastic resin onto the faying surface of a thermoplastic substrate S1 to form a grid pattern of protrusions 14 and narrow channels 16, where one or more localized regions of additively manufactured protrusions are formed to be thicker than other regions of the protrusions (e.g., the localized thicker regions correspond to the locations of gaps between the faying surfaces of the substrates S1, S2 when the substrates were dry fit in step 1012).

After forming the energy director in step 1014, the method 1010 proceeds to step 1016 wherein an ultrasonic welding tool is used to form the ultrasonic weld between the substrates S1, S2. During the welding step 1016, the energy director 12 concentrates vibrational energy at each protrusion 14, leading to rapid, localized melting at the joint interface. Moreover, since the protrusions 14 are densely distributed across the entire weld area, focused melting occurs along the entire surface area of the weld, resulting in a strong, consistent weld. Further, the varied thickness of the energy director 12 fills the gaps between the substrates, yielding a continuous weld joint that is substantially free of voids or other discontinuities.

### EXAMPLE

A test was conducted to compare the mechanical properties of an ultrasonic weld formed in accordance with the principles of the present disclosure with other ultrasonic welds. The test conditions were as follows: Sample weld layups 10 in accordance with the present disclosure were prepared and a corresponding number of samples of five comparative example weld layups C1, C2, C3, C4, C5 were also prepared. The samples of the example weld layup 10 and each comparative example weld layup C1, C2, C3, C4, C5 all used first and second substrates S1, S2 formed from Toray TC1225 (LMPAEK/T700GC) with a [0/−45-90/−45] layup, having 16 plies and 0.080-inch thickness.

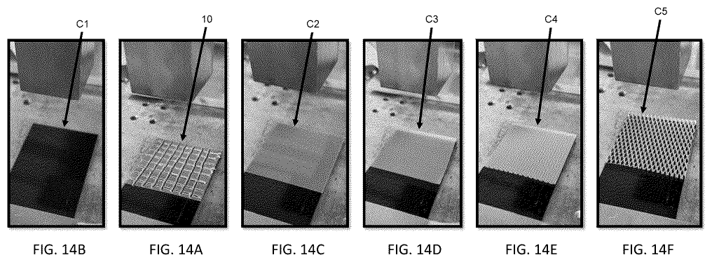

FIGS. 14A-14F depict representative examples of the samples with the upper substrate removed. As shown in FIG. 14A, in the example weld layup 10, an energy director 12 in accordance with the present disclosure was formed on the first substrate S1. The example energy director 12 was formed from AE250 200 μm film that was melted and shaped to include narrow channels 16 defining protrusions 14. As shown in FIG. 14B, in comparative example C1, no energy director was placed on the substrate S1. As shown in FIG. 14C, in comparative example C2, a flat strip of AE250 200 μm film was placed on the first substrate S1 as the energy director. As shown in FIG. 14D, in comparative example C3, a sheet of 4 PAEK resin mesh (e.g., 4 PAEK 8-050×9.45 Resin Mesh) was placed on the first substrate S1. As shown in FIG. 14E, in comparative example C4, a sheet of 16 PAEK resin mesh (e.g., 16 PAEK 16-100×9.45 Resin Mesh) was placed on the first substrate S1. As shown in FIG. 14F, in comparative example C5, a sheet of 200 PAEK resin mesh (e.g., 200 PAEK 2.0 EII 31×9.45 Resin Mesh) was placed on the first substrate S1.

In each sample, the second substrate S2 was positioned atop the first substrate S1 in a lap configuration. Each sample weld layup was subjected to an ultrasonic welding process using the same ultrasonic welding tool and process conditions. Finally, the welded parts created from each sample were subjected to shear strength testing.

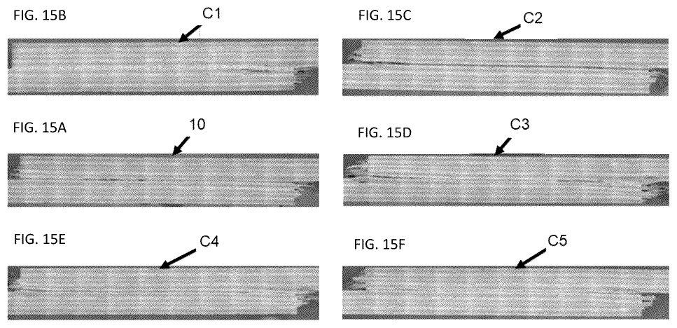

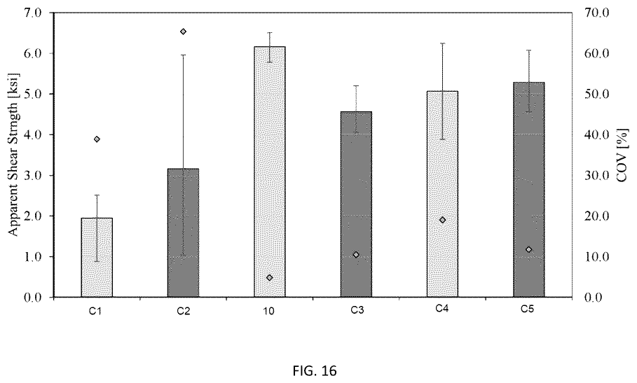

Micrographs of each of the weld joints formed according to the test procedure described above are shown in FIGS. 15A-15F, where FIG. 15A is a micrograph of a sample of the example 10, FIG. 15B is a micrograph of a sample of the comparative example C1, FIG. 15C is a micrograph of a sample of the comparative example C2, FIG. 15D is a micrograph of a sample of the comparative example C3, FIG. 15E is a micrograph of a sample of the comparative example C4, and FIG. 15F is a micrograph of a sample of the comparative example C5. FIG. 16 is a chart that shows the apparent shear strength of the joints produced by each of the weld layups. In FIG. 16, the bar for each example represents the apparent shear strength measurement in ksi, and the diamond point for each example represents the coefficient of variance among the samples for the example. The bracketed line for each sample shows the actual range of variance in shear strength measured for the samples of the respective example. As shown, the example weld layup 10 according to the present disclosure produced a notably stronger weld joint than any of the comparative examples C1, C2, C3, C4, C5.

Accordingly, it can be seen that the present disclosure provides an energy director 12 for use in an ultrasonic welding process that promotes complete fusion of the interface with consistent and repeatable results through high efficiency localized heating of the weld interface.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A method of using ultrasonic welding for fusion bonding of thermoplastic composites, the method comprising:
forming an energy director in place on a first thermoplastic substrate; and
ultrasonically welding the first thermoplastic substrate to a second thermoplastic substrate with the energy director sandwiched between the first and second thermoplastic substrates;
wherein said forming the energy director comprises placing thermoplastic film on the first thermoplastic substrate, melting the thermoplastic film, and stamping the thermoplastic film with an energy director stamp.

2. The method of claim 1, wherein the energy director stamp comprises a waffle shaped stamping surface.

3. The method of claim 1, wherein said forming the energy director comprises forming a plurality of energy director protrusions on the first thermoplastic substrate out of the thermoplastic film.

4. The method of claim 1, wherein said ultrasonically welding comprises using a continuous ultrasonic welding tool to make a continuous ultrasonic weld.

5. The method of claim 4, wherein the continuous ultrasonic welding tool comprises:
a sonotrode, configured to receive and apply vibrations to make a weld between the first and second thermoplastic substrates;
at least one pressure applicator system, the pressure applicator system comprising a first pressurization element and a second pressurization element, the sonotrode located between the first pressurization element and the second pressurization element; and
a movement system configured to move the sonotrode and the at least one pressure applicator system to (i) compress the first and second thermoplastic substrates together ahead of the sonotrode in the movement direction using the first pressurization element and (ii) compress the first and second thermoplastic substrates together behind the sonotrode relative the movement direction using the second pressurization element while the sonotrode apply vibrations to make a weld between the first and second thermoplastic substrates.

6. The method of claim 5, wherein the first pressurization element and the second pressurization element comprise carriages supporting wheels, the wheels being configured to roll along the part without snagging on fibers.

7. The method of claim 6, wherein the wheels are compaction rollers.

8. The method of claim 7, wherein the movement system comprises one of a mobile gantry or multi-axial robot.

9. A method of using ultrasonic welding for fusion bonding of thermoplastic composites, the method comprising:
forming an energy director in place on a first thermoplastic substrate; and
ultrasonically welding the first thermoplastic substrate to a second thermoplastic substrate with the energy director sandwiched between the first and second thermoplastic substrates;
wherein said forming the energy director comprises forming energy director protrusions arranged in a grid pattern.

10. The method of claim 9, wherein said ultrasonically welding comprises forming weld having a length and width.

11. The method of claim 10, wherein said forming the energy director comprises forming the energy director so that the grid pattern spans the entire length and width of the weld.

12. The method of claim 9, wherein said forming the energy director comprises additively manufacturing the energy director directly onto the first thermoplastic substrate.

13. The method of claim 12, wherein said additively manufacturing the energy director comprises additively manufacturing an energy director primitive onto the first thermoplastic substrate and subsequently machining the additively manufactured energy director primitive to form a final energy director.

14. The method of claim 9, wherein said forming the energy director comprises applying a film strip on the first thermoplastic substrate and subsequently shaping the film strip to form the grid pattern.

15. The method of claim 14, wherein said shaping comprises rolling a roller along the film strip.

16. The method of claim 15, wherein said rolling is performed by an industrial automation robot.

17. The method of claim 14, wherein said shaping comprises pressing a stamp block against the film strip.

18. The method of claim 9, wherein said forming the energy director comprises forming the energy director so that at least some of the energy director protrusions have different thicknesses.

19. The method of claim 18, wherein said forming the energy director comprises locating one or more gaps between the first and second substrates before said forming the energy director and wherein said forming the energy director comprises forming energy director protrusions of greater thickness at the gaps.

20. A thermoplastic composite weld layup comprising a thermoplastic composite substrate having a weld joint region and a thermoplastic energy director formed in place along the weld joint region, wherein the thermoplastic energy director comprises thermoplastic film stamped onto the weld joint region such that the film material forms discrete energy director protrusions arranged in a grid pattern along the weld joint region.
